(19) United States
(12) Patent Application Publication
(10) Pub. No.: US 2009/0088876 A1
(43) Pub. Date: Apr. 2, 2009

(54) PORTABLE, DIGITAL MEDIA PLAYER AND ASSOCIATED METHODS

(76) Inventors: Kevin M. Conley, San Jose, CA (US); Bill Thanos, Scotts Valley, CA (US); Keith Washo, San Jose, CA (US); Ronald Chung, Millbrae, CA (US)

Correspondence Address: SANDISK CORPORATION;JENKINS, WILSON, TAYLOR & HUNT, P.A., SUITE 1200 UNIVERSITY TOWER, 3100 TOWER BOULEVARD, DURHAM, NC, 27707, US

(21) Appl. No.: 11/863,790

(22) Filed: Sep. 28, 2007

(51) Int. Cl. G06F 17/00

(52) U.S. Cl. 700/94

(57) ABSTRACT

The present media player includes alternative indicators, other than a graphical user interface, to facilitate user control. In one embodiment the player includes an illuminable indicator comprising a plurality of LED's. The LED's are configured to illuminate and dim according to a variety of different illumination patterns to indicate, for example, an operational mode of the player. In some embodiments the player is configured to generate auditory signals to indicate to the user that it is tuned to a particular preset station. In some embodiments the player includes apparatus for tracking one or more user parameters, such as heart rate. In some embodiments the player may be configured with a play list matching a tempo profile of an exercise program. Several methods related to the player are also disclosed.

### BACKGROUND

1. Technical Field

The present invention relates to portable, digital media players.

2. Description of Related Art

Many portable, digital media players include a graphical user interface (“GUI”). The GUI typically displays a plurality of menus from which a user can select in order to control the player. For example, the user can navigate through menus displayed on the GUI in order to change an operational mode of the player and to skip from one song to the next. The GUI also typically displays information about the media stored on the player, such as the names of artists and songs.

A GUI must be at least a minimum size in order to be useful as a user-readable display. Also, a GUI requires additional circuitry and other components beyond what is required for a media player having no GUI. Thus, the GUI itself and its related components increase the size and weight of the player as compared to a player having no GUI. The greater size and weight are disadvantageous for several reasons. For example, many users enjoy listening to music while exercising. For these users it is advantageous for the media player to be as small and light as possible, so that it does not interfere with the user or weigh the user down while he or she exercises.

### SUMMARY OF THE INVENTION

The various embodiments of the present portable, digital media player having no graphical user interface, and associated methods have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description”, one will understand how the features of the present embodiments provide advantages, which include an elegant and easy to understand indication of various characteristics of the player, including its operational mode, the ability to customize the player with a play list that matches a tempo of an exercise program, and the ability to track user data while exercising.

One embodiment of the present media player and associated methods comprises a method of changing an operational mode of a portable, digital media player. The media player includes no graphical user interface. The method comprises the step of depressing a button of the player to change the operational mode of the player from a first operational mode to a second operational mode. When the player changes from the first operational mode to the second operational mode a plurality of LED's associated with the player changes from a first illumination pattern to a second illumination pattern. It is noteworthy that only a single LED may be used to change illumination pattern.

Another embodiment of the present media player and associated methods comprises a method of indicating an operational mode of a portable, digital media player. The media player includes no graphical user interface. The method comprises the steps of: illuminating a plurality of LED's associated with the player according to a first illumination pattern when the player is in a first operational mode; and illuminating the LED's according to a second illumination pattern when the player is in a second operational mode.

Another embodiment of the present media player and associated methods comprises a method of indicating that a portable, digital media player is in a hold mode or locked mode. The media player includes no graphical user interface. The method comprises the steps of: illuminating a plurality of LED's associated with the player according to a first illumination pattern when the player is in a first operational mode; depressing a button of the player, the button being configured to change an operational mode of the player from the first operational mode to a second operational mode; and illuminating the LED's according to a second illumination pattern to indicate that the player is in the hold mode or locked mode and cannot be changed to the second operational mode.

Another embodiment of the present media player and associated methods comprises a method of indicating that a portable, digital media player is changing from a first operational mode to a second operational mode. The media player includes no graphical user interface. The method comprises the steps of: illuminating a plurality of LED's associated with the player according to a first illumination pattern when the player is in a first operational mode: depressing a button of the player, the button being configured to change an operational mode of the player from the first operational mode to the second operational mode; and illuminating the LED's according to a second illumination pattern when the player is changing from the first operational mode to the second operational mode.

Another embodiment of the present media player and associated methods comprises a method of configuring a portable, digital media player with preset channels. The media player includes no graphical user interface. The method comprises the steps of: connecting the media player to a computer (or a host system with a display and an input device); reading a first set of metadata from the media player, the first set of metadata corresponding to a first preset channel; changing the first preset channel on the media player to a second preset channel; and updating the media player with a second set of metadata corresponding to the second preset channel.

Another embodiment of the present media player and associated methods comprises a method of changing a portable., digital media player from a first preset channel to a second preset channel. The media player includes no graphical user interface. The method comprises the steps of: depressing a button of the player to change from the first preset channel to the second preset channel; and generating an auditory signal to indicate to a user that the player is tuned to the second preset channel.

Another embodiment of the present media player and associated methods comprises a method of configuring a portable, digital media player to provide music at desired tempos to match an exercise program. The media player includes no graphical user interface. The method comprises the steps of: connecting the media player to a computer; generating, from the exercise program, a tempo profile; searching an audio database to locate music files that fit the tempo profile; building a play list from the music files; and loading the play list to the media player.

Another embodiment of the present media player and associated methods comprises a method of tracking a user parameter during exercise. The media player includes no graphical user interface. The method comprises the steps of: securing a portable, digital media player to the user, the player being configured to collect data regarding the user parameter while the user exercises; configuring the media player to enable data collection; and collecting the data using the media player.

Another embodiment of the present media player and associated methods comprises a portable, digital media player including no graphical user interface. The player comprises a button configured to change an operational mode of the player when depressed. An illuminable indicator of the player includes a plurality of LED S. The LED's are configured to illuminate according to a first illumination pattern when the player is in a first operational mode and to illuminate according to a second illumination pattern when the player is in a second operational mode.

Another embodiment of the present media player and associated methods comprises a portable, digital media player including no graphical user interface. The player comprises a button configured to change an operational mode of the player when depressed. An illuminable indicator of the player includes a plurality of LED's. The LED's are configured to illuminate according to a first illumination pattern when the player is in a hold mode or locked mode and the button is depressed.

Another embodiment of the present media player and associated methods comprises a portable, digital media player including no graphical user interface. The player comprises a button configured to change the player from a first preset channel to a second preset channel. The player further comprises an auditory signal generator configured to indicate to a user that the player is tuned to the second preset channel.

Another embodiment of the present media player and associated methods comprises a portable, digital media player including no graphical user interface. The player comprises apparatus configured to track a user parameter during exercise.

### BRIEF DESCRIPTION OF THE DRAWINGS

The various embodiments of the present media player and associated methods will now be discussed in detail with an emphasis on highlighting the advantageous features. These embodiments depict the novel and non-obvious media player and associated methods shown in the accompanying drawings, which are for illustrative purposes only. These drawings include the following figures, in which like numerals indicate like parts:

FIG. 1 is a front perspective view of one embodiment of the present portable, digital media player having no graphical user interface:

FIG. 2 is a schematic diagram of components of the media player of FIG. 1 and a host system;

FIG. 3 is a schematic diagram of one embodiment of a host system configured for use with the media player of FIG. 1;

FIG. 4 is a circuit diagram illustrating one embodiment of a configuration for LED's of the media player of FIG. 1;

FIG. 5 is a schematic diagram of components of another embodiment of the present portable, digital media player and a host system;

FIG. 6 is a schematic diagram of components of another embodiment of the present portable, digital media player and a host system;

FIG. 7 is a flowchart illustrating one embodiment of a method of changing an operational mode of a portable, digital media player;

FIG. 8 is a flowchart illustrating one embodiment of a method of indicating an operational mode of a portable, digital media player;

FIG. 9 is a flowchart illustrating one embodiment of a method of indicating that a portable, digital media player is in a hold mode or locked mode;

FIG. 10 is a flowchart illustrating one embodiment of a method of indicating that a portable, digital media player is changing from a first operational mode to a second operational mode;

FIG. 11 is a flowchart illustrating one embodiment of a method of configuring a portable, digital media player with preset channels;

FIG. 12A is a flowchart illustrating one embodiment of a method of changing a portable, digital media player from a first preset channel to a second preset channel;

FIG. 12B shows an example of a preset sequence, according to one embodiment;

FIG. 13 is a flowchart illustrating one embodiment of a method of tracking a user parameter during exercise;

FIG. 14 is a flowchart illustrating one embodiment of a method of configuring a portable, digital media player to provide music at desired tempos to match an exercise program; and

FIGS. 15A-15C show examples of matching audio files with exercise programs, according to one embodiment.

### DETAILED DESCRIPTION

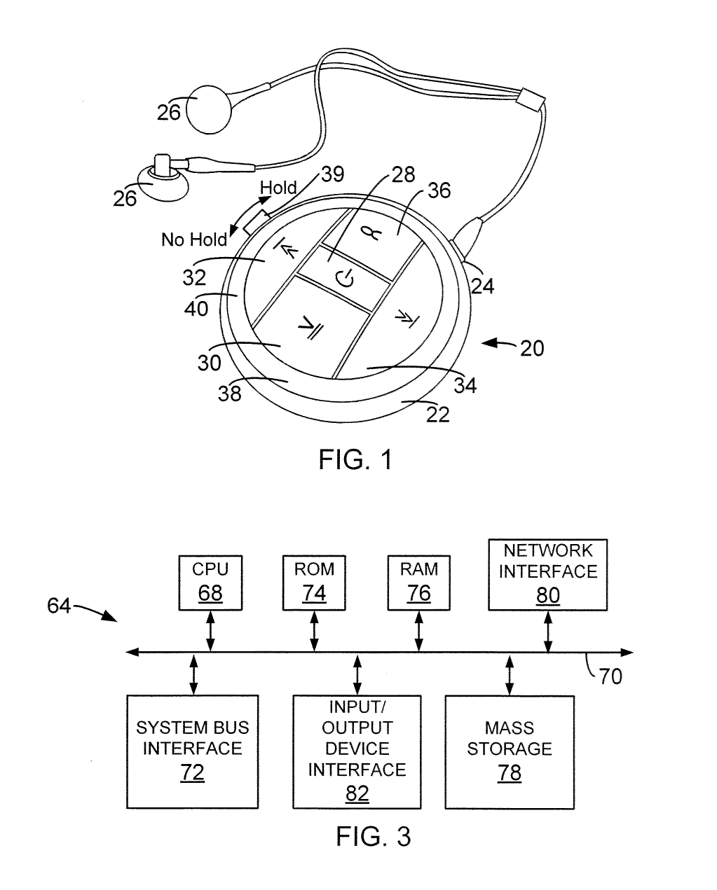

FIG. 1 illustrates one embodiment of the present portable, digital media player 20. The player 20 advantageously includes no graphical user interface (“GUI”). The player 20 is thus very compact and light, making it well suited for use while exercising or while participating in any activity where it is advantageous for a media player to be less bulky. It is also less expensive to manufacture than a comparable player including a GUI. Because the player does not include a GUI, it includes alternative indicators that facilitate user control. These indicators are discussed in detail below.

The player 20 includes a housing 22 that is shaped generally as a disk. Those of ordinary skill in the art will appreciate that the housing 22 could have any other shape, such as rectangular. The housing 22 includes a jack 24 configured for connecting headphones 26 and/or audio speakers (not shown). A power source (not shown) within the housing 22, such as a rechargeable battery provides electrical power for operating the player 20. If the power source is a rechargeable battery, the jack 24 may be configured to receive a plug of a wall adapter (not shown) to enable recharging of the battery using AC power from a wall outlet. Player 20 may be coupled to a host system using one or more jacks (not shown) for configuration and/or downloading play lists.

The player 20 further includes a plurality of buttons. In the illustrated embodiment, five buttons are provided: a power button 28, a play/pause button 30, a rewind/track return button 32, a fast forward/track skip button 34 and a mode change button 36. Those of ordinary skill in the art will appreciate that fewer or more buttons may be provided, that the buttons may have more and/or different functions, and that the buttons may be arranged differently than as shown. Those of ordinary skill in the art will further appreciate that certain embodiments of the present player 20 may not include any buttons at all and instead touch sensors or any other input technology may be used.

The player 20 may also include a button or switch 39 configured to place the player 20 in a hold mode or locked mode. In the hold mode or locked mode the buttons on the player 20 are disabled so that accidental depression of a button does not affect the operational status of the player 20.

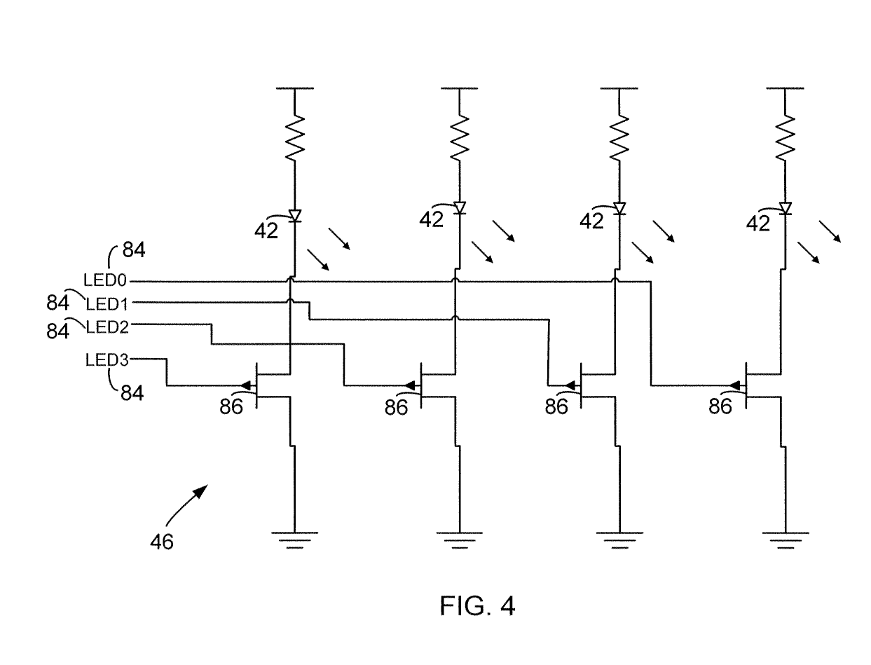

The player 20 also includes an illuminable indicator 38. In the illustrated embodiment, the indicator 38 comprises a transparent or translucent ring 40 extending around a front face of the player 20 near a perimeter thereof. Behind the ring 40, the player 20 contains a plurality of light-emitting devices, such as light-emitting diodes (LED's). The LED's 42 (FIG. 4) are configured to illuminate and dim according to a variety of different illumination patterns, as discussed in detail below. As the LED's 42 illuminate, light emanates through the transparent or translucent ring 40, giving the user a visual indication of, inter alia, an operational mode of the player 20.

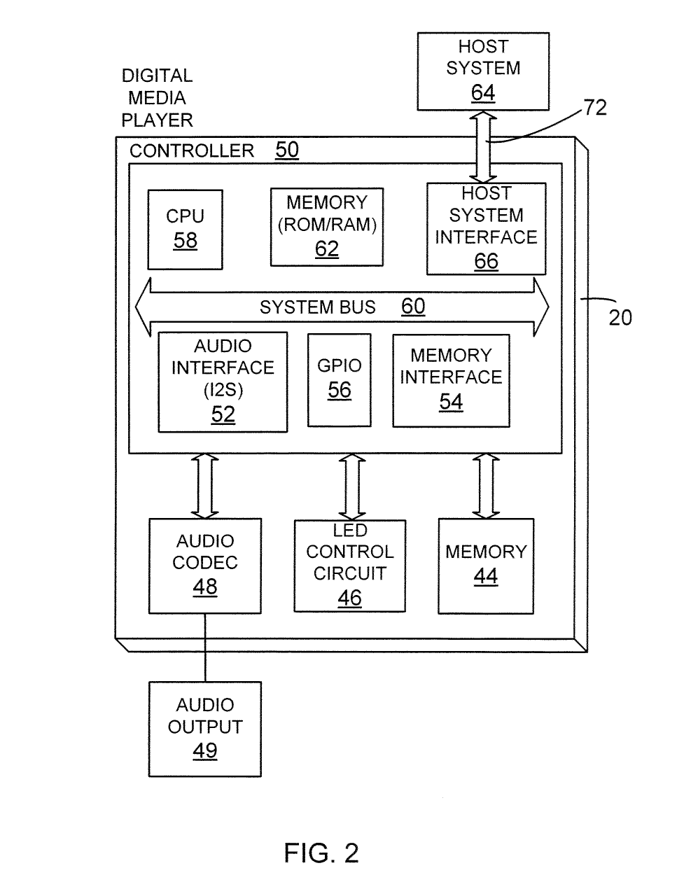

FIG. 2 provides a schematic block diagram of one configuration for components of the player 20. With reference to FIG. 2, the player 20 comprises erasable and rewritable non-volatile memory 44 (also referred to as memory 44) configured to store media files, such as audio and/or music files. The files may be in any format, such as FLAC, AAC, WAV, WMA, and/or MP3. The memory 44 includes a plurality of solid-state memory modules or cells (not shown). In one embodiment the memory 44 is flash memory, such as that having a NAND architecture (including multi-level cell technology) or other architectures, such as NOR. Examples of NAND flash memories and their operation as part of a memory system are available in U.S. Pat. Nos. 5,570,315, 5,774,397, 6,046,935, 6,373,746, 6,456,528, 6,522,580, 6,771,536 and 6,781,877, and United States Patent Application Publication No. 2003/0147278. Each of the foregoing references is hereby incorporated by reference.

The memory 44 may be built into the player 20, or it may be removable. For example, the memory 44 may be provided on a card that may be removed from and reinserted into the player 20. There are currently many different types of flash memory cards that are commercially available, such as the CompactFlash (CF), the MultiMediaCard (MMC). Secure Digital (SD), miniSD, Memory Stick, SmartMedia and TransFlash cards. Each of these cards has a unique mechanical and/or electrical interface according to its standardized specifications, for example, The Universal Serial Bus (USB) specification, incorporated herein by reference in its entirety. Nevertheless, the flash memory included in each is very similar. These cards are all available from SanDisk Corporation, assignee of the present application.

With continued reference to FIG. 2, the player 20 further comprises an LED control circuit 46, which controls the illumination and dimming of the LED's 42. An audio compressor/de-compressor, or codec 48, encodes a stream of digital audio information for storage in the non-volatile memory 44, and decodes the information for listening; or encoded digital audio data is transferred via host system interface 66. Audio CODEC 48 may include an amplifier and may be used to generate an audio output 49. Audio output 49 may be provided via a speaker or a headset, or any other such device.

The player 20 further comprises a controller 50 that controls the overall functionality of the player 20. The controller 50 includes an audio interface 52 that facilitates communication between the audio codec 48 and the controller 50, and a non-volatile memory interface 54 that facilitates communication between the non-volatile memory 44 and the controller 50. Memory interface 54 may be memory (for example, NAND, SDRAM and others) or logical block address (LBA) based (for example, ATA (Advanced Technology Attachment), SD and others). A general-purpose input/output unit (GPIO) interface 56 provides general-purpose pins that may be configured as input or output pins. An example of controller architecture is provided in co-pending patent application, Ser. No. 11/250,094, filed on Oct. 13, 2005 (incorporated herein by reference in its entirety), assigned to SanDisk Corporation, the assignee of the present application.

A central processing unit (CPU, or microprocessor) 58 interprets and executes instructions and processes data. The CPU 58 interfaces with a system bus 60 through which it can communicate with other components of the controller 50. A memory unit 62 is coupled to the system bus 60 and provides CPU 58 with access to memory storage. When executing program instructions, (for example, firmware instructions and executable code according to the embodiments described below) the CPU 58 stores those process steps in memory 62 and executes the stored process steps out of memory 62. Memory 62 includes random access memory (RAM) circuits and may located on the same chip as controller 50, off-chip or a combination thereof.

The player controller 50 interfaces with a host system 64 via a host system interface 66. The host system interface 66 includes a port (not shown) for receiving a data cable (not shown). The port may be any type, such as USB, USB 2.0, parallel port, RS232, SCSI or any other type of port. It is noteworthy that player 20 may interface with host system 64 via a wireless connection (for example, WiFi, UWB, WiMAX, 3G, CDMA and others). The various embodiments described herein are not limited to any particular interface type.

FIG. 3 illustrates a typical host system 64 to which the player 20 may be connected. Host system 64 includes a CPU (or microprocessor) 68 connected to a system bus 70. Host system 64 connects with the player 20 via a player interface 72. Player interface 72 may be a standard interface, for example, a USB interface or any other interface type. CPU 68 executes program instructions out of RAM 76. Read only memory (ROM) 74 is provided to store invariant sequences such as start-up instruction sequences or basic input/output operating system (BIOS) sequences. A mass storage device 78, such as a hard disk drive or a solid storage device (for example, a memory card), is also connected to the system bus 70 and enables the host system 64 to store, for example, program files and data files.

The host system 64 may connect to a computer network (not shown) via a network interface 80 and through a network connection (not shown). One such network is the Internet, which allows the host system 64 to download multi-media content (audio/video files) applications, code, documents and others electronic information. An input/output (I/O) device interface 82 allows the host system 64 to connect to various input/output devices (not shown), such as a keyboard, a pointing device (mouse), a display monitor, a printer, a modem, etc. The I/O device interface 82 is shown as a single block for simplicity and may include plural interfaces to interface with different types of I/O devices. It is noteworthy that player interface 72 may be a part of input/output device interface 82. Those of ordinary skill in the art will appreciate that the illustrated host system 64 is not integral to the present embodiments, and that the player 20 may be connected to any host system having all, some or none of the components illustrated in FIG. 3.

FIG. 4 illustrates one embodiment of the LED control circuit 46 of FIG. 2. The illustrated control circuit 46 includes four LED's 42. However, those of ordinary skill in the art will appreciate that embodiments of the present player 20 may include fewer or more LED's 42. The control circuit 46 further includes four control signals 84 and four switches 86. Each LED 42 includes one corresponding control signal 84 and one corresponding switch 86. Each control signal 84 and switch 86 control the illumination and dimming of only one corresponding LED 42.

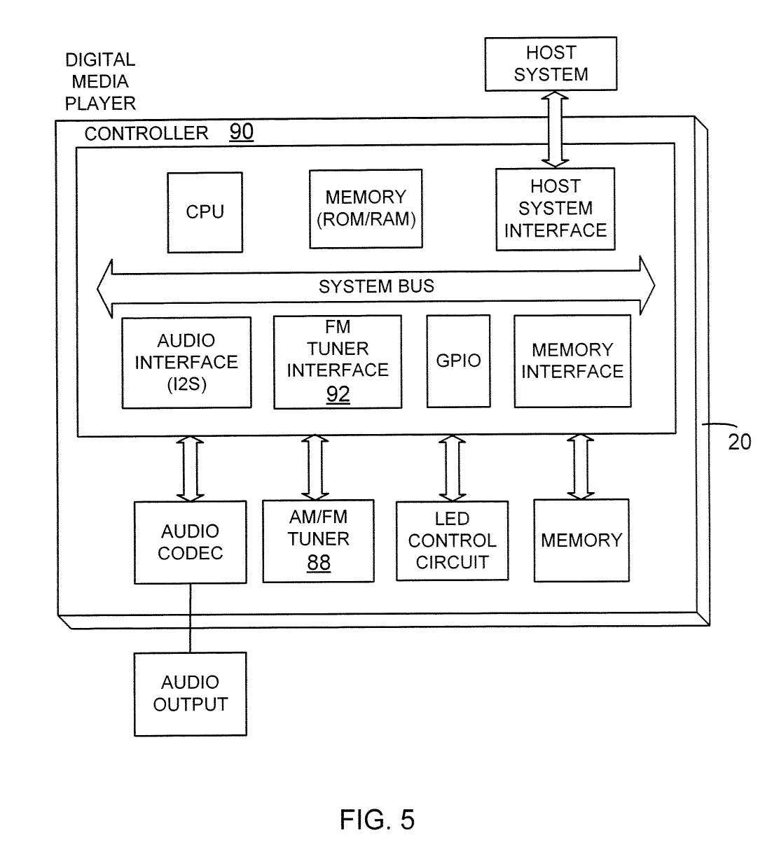

FIG. 5 illustrates an alternative configuration for components of the present media player 20. FIG. 5 includes each of the components shown in FIG. 2. However, in addition the player 20 includes a radio tuner 88 that enables the player 20 to receive radio broadcast signals (for example, AM/FM, HD, satellite radio and other type of radio signals). The controller 90 of FIG. 5 also includes a radio tuner interface 92 that enables the controller to interface with the radio tuner 88. Those of ordinary skill in the art will appreciate that in certain embodiments the player may include either an AM tuner or an FM tuner (and associated interface), rather than both an AM and an FM tuner; or any other type of radio broadcast receiver (for example, HD satellite broadcast). For simplicity, however, the term radio will be used herein to refer to any such configurations in a generic sense.

In certain embodiments, player 20 is configured to provide the user with auditory signals to indicate that the player is tuned to a particular radio station. For example, when a user depresses a button on the player 20, such as either the rewind/track return button 32, or the fast forward/track skip button 34, the player 20 may change from a first preset channel to a second preset channel. At the same time the player 20 may generate an auditory signal to indicate that the player 20 is tuned to the second preset channel. The auditory signal may comprise a human sounding voice reading an amplitude or frequency of the second preset channel. For example, the user may hear a voice say “preset channel five, one-o-three point one, FM.” The auditory signal may also include additional information about the preset channel, such as station identifier (ID) (for example, KROQ), a short description of the music or other programming typically broadcast by that channel. The short description may include a genre of the music that the user is likely to hear on that channel. The auditory signal may be generated by using a “text to voice” function where text is converted to audio; by using preloaded audio files (i.e. metadata with presets) or by any other means, as described below.

In embodiments of the present player 20 including the radio tuner 88, a user may connect the player 20 to a computer in order to reconfigure station presets. For example, upon connecting the media player 20 to a computer the computer may read metadata from the media player 20 corresponding to the preset channels programmed into the player 20. The metadata may include information about the channel, such as its amplitude/frequency, the genre of music/programming on that channel, station ID and others. These presets, and their corresponding metadata, may be displayed to the user on the computer screen. The user may then replace a first preset channel on the media player with a second preset channel. The computer may then update the media player 20 with metadata corresponding to the second preset channel. When the user later disconnects the player 20 from the computer and tunes to the second preset channel, he or she will hear the metadata associated with the second preset channel.

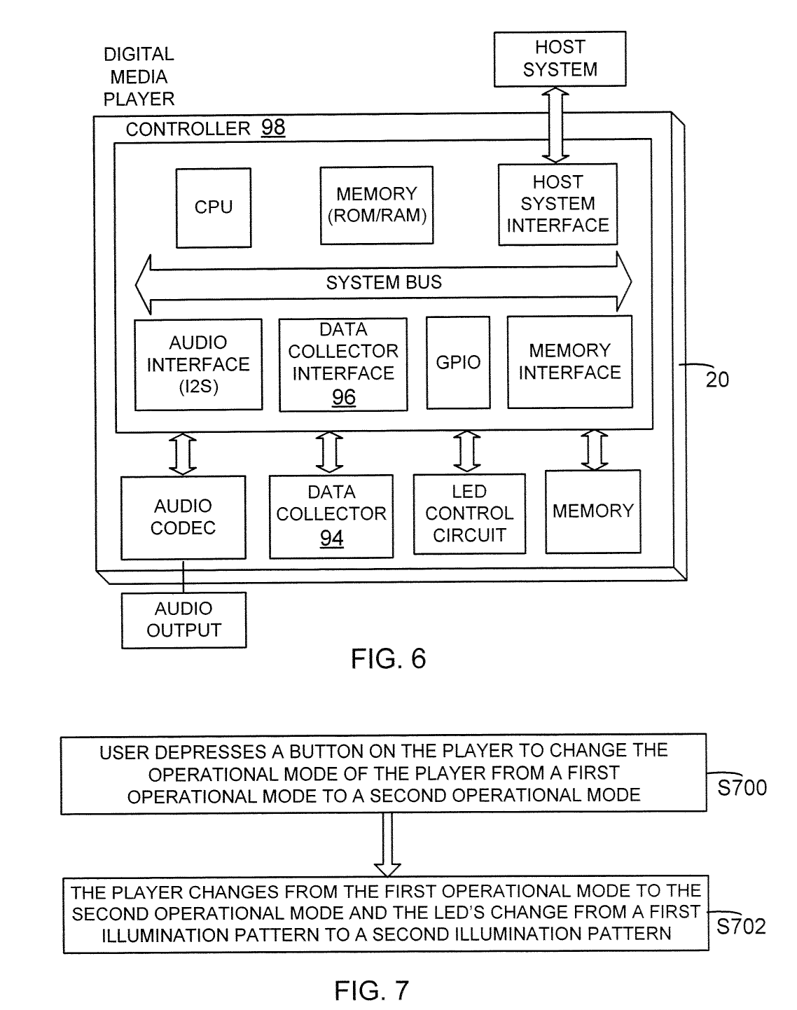

FIG. 6 illustrates another alternative configuration for components of the present media player 20. FIG. 6 also includes each of the components shown in FIG. 2. However, in addition the player 20 includes a data collector 94. The controller of FIG. 6 also includes a data collector interface 96 that enables the controller 98 to interface with the data collector 94. The data collector 94 may include a heart rate monitor and/or a pedometer or any other device to collect information regarding a user parameter. As the user exercises with the player 20, the data collector 94 collects data from the user regarding one or more user parameters. For example, the user parameter(s) may be his or her heart rate, distance traveled and/or average speed. The user may keep a log of the collected data so that he or she can track his or her performance and perhaps also track his or her progress through a training program. In order to maintain the log, the user may connect the media player 20 to a computer and upload the data to the computer. The data may be stored in a database, which may be located on the computer or on a network. The user may also share the data with others, such as fellow training partners or a personal trainer to track user progress and compare collected data with group statistics. In order to share the data, the user may register with a network-based database. Therefore, one step of a method of sharing the data may comprise the user logging into the database and/or the database detecting whether the user is registered with the database. The controller of FIG. 6 also includes a data collector interface 96 that enables the controller 98 to interface with the data collector 94.

In certain embodiments the present media player 20 may be configured to provide music at desired tempos to match an exercise program. For example, a user may connect the media player 20 to a computer. The user may then create an exercise program either by generating one from scratch or by selecting a readymade program from a list. An example program, which may be suited for running up and down a hill repeatedly, may comprise three minutes of music at a fast tempo followed by three minutes of music at a slow tempo. Once the exercise program has been created, a tempo profile may be generated from the exercise program. The computer and/or user may then search an audio database to locate music files that fit the tempo profile. The audio database may be located on the computer or on a network, such as the Internet, to which the computer is connected. As suitable music files are located, a play list is built from the music files, and the play list is loaded to the media player 20.

The illuminable indicator 38 of the present media player 20 provides a variety of illumination patterns to indicate various operational modes of the player 20, and to indicate other characteristics of the player 20. For example, the various illumination patterns may indicate a current operational mode of the player 20, or they may indicate that the player 20 is in a process of changing from one operational mode to another, or they may indicate that the player 20 is in a hold mode or locked mode and cannot be changed to another operational mode or song tempo.

Those of ordinary skill in the art will appreciate that the term “illumination pattern” is used broadly in the present application to mean any visual characteristic of the illuminable indicator 38. Illumination pattern may refer to a sequence of illumination of the LED's 42, or it may refer to a color or colors of the illuminable indicator 38, a brightness of the illuminable indicator 38, etc. For example, a first illumination pattern of the player 20 may correspond to the illuminable indicator 38 being colored blue, and a second illumination pattern of the player 20 may correspond to the illuminable indicator 38 being colored red. The blue color may indicate, for example, that the player 20 is in a play mode, while the red color may indicate that the player 20 is in a hold mode or locked mode and cannot be changed to a different operational mode.

In another embodiment, a first illumination pattern of the player 20 may correspond to the LED's 42 behind the illuminable indicator 38 illuminating and dimming in sequence, and a second illumination pattern of the player 20 may correspond to the LED's 42 behind the illuminable indicator 38 illuminating and dimming in random order. In this embodiment, the LED's 42 may be arranged in a ring, such that as they light and dim in sequence the user observes a source of light traveling in a ring around the illuminable indicator 38. The sequential illuminating and dimming may indicate that the player 20 is playing a series of songs, such as from a play list, in a sequential order, while the random illuminating and dimming may indicate that the player 20 is playing a play list in a random order. In both the sequential and random illuminating and dimming patterns, more than one LED may be illuminated at any given moment.

FIG. 7 illustrates a method of changing an operational mode of the player 20. At step S700, a user depresses the mode button on the player 20 to change the operational mode of the player 20 from a first operational mode to a second operational mode. When the button is depressed the LED'S 42 in the illuminable indicator 38 change from a first illumination pattern to a second illumination pattern, as shown at step S702. The change in the illumination pattern provides the user with a visual cue of the change in operational mode. As described above, the illumination pattern may change from sequential illuminating and dimming to random illuminating and dimming, indicating that the player 20 has changed from a sequential play order to a random play order.

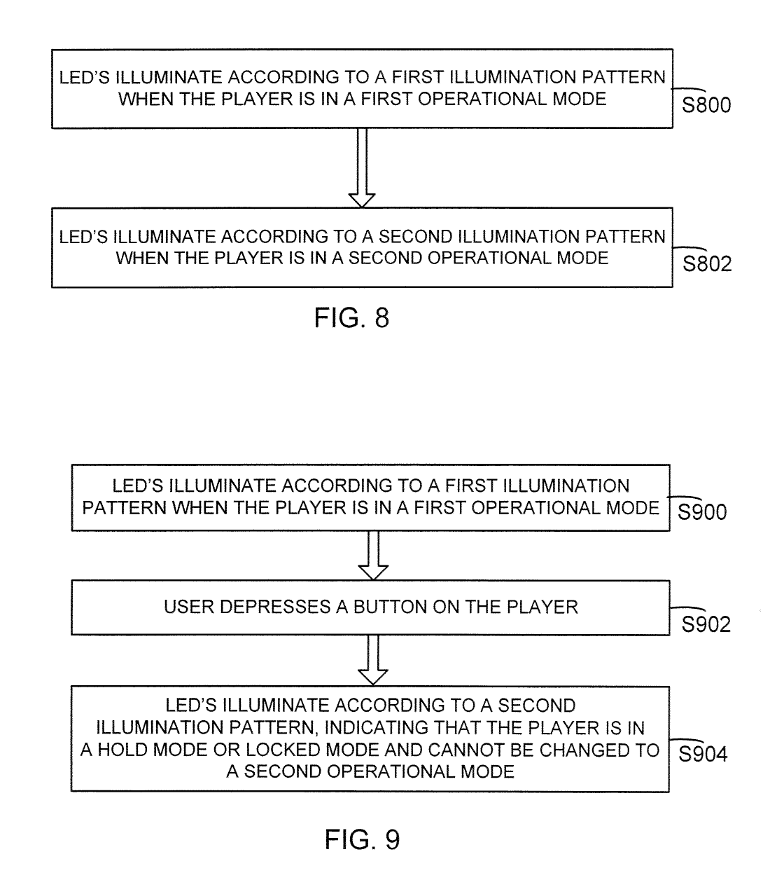

FIG. 8 illustrates a method of indicating an operational mode of the player 20. In step S800 the LED's 42 illuminate according to a first illumination pattern when the player 20 is in a first operational mode. In step S802 the LED'S 42 illuminate according to a second illumination pattern when the player 20 is in a second operational mode.

FIG. 9 illustrates a method of indicating that the player 20 is in a hold mode or locked mode. At step S900 the LED'S 42 illuminate according to a first illumination pattern to indicate that the player 20 is in a first operational mode. At step S902 a user depresses the mode button 36 of the player 20. At step S904 the LED S 42 illuminate according to a second illumination pattern. The second illumination pattern indicates that the player 20 is in a hold mode or locked mode and cannot be changed to a second operational mode. In some embodiments the second illumination pattern may comprise a change in the illumination color of the LED's 42 (such as from blue to red), and/or a flashing or blinking of the LED's 42. The player 20 may be configured to illuminate the illuminable indicator 38 in the second illumination pattern for only a limited amount of time, such as a few seconds, after which the illuminable indicator 38 may automatically revert to the first illumination pattern to indicate that the player 20 is in the first operational mode.

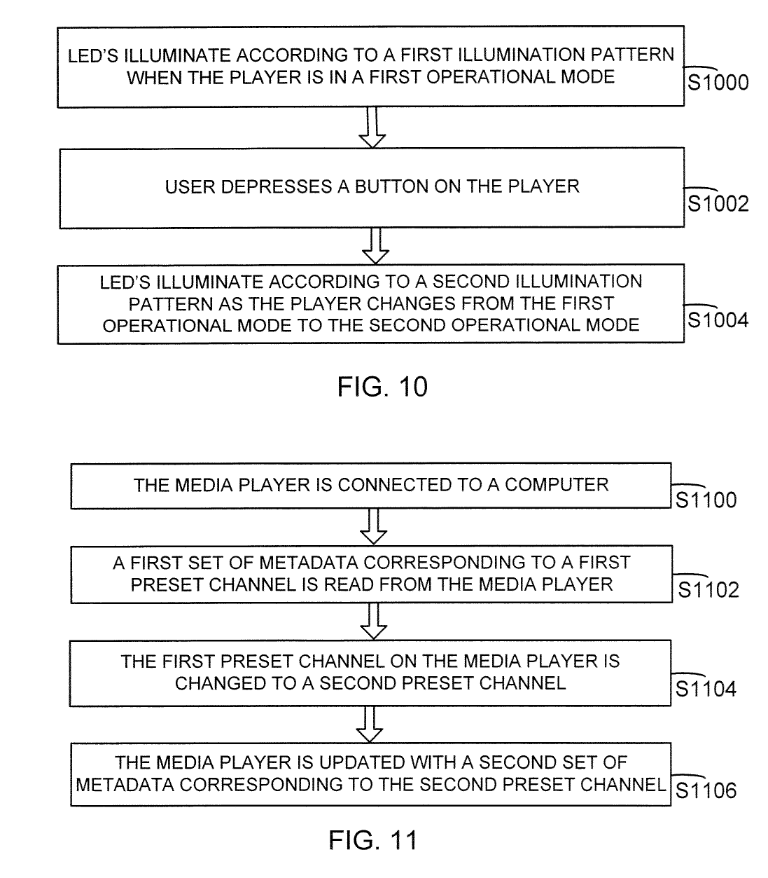

FIG. 10 illustrates a method of indicating that the player 20 is changing from a first operational mode to a second operational mode. At step S1000 the LED'S 42 illuminate according to a first illumination pattern to indicate that the player 20 is in a first operational mode. At step S1002 a user depresses the mode button on the player 20. At step S1004 the LED'S 42 illuminate according to a second illumination pattern as the player 20 changes from the first operational mode to the second operational mode.

FIG. 11 illustrates a method of configuring the player 20 with preset channels. At step S1100 the media player 20 is connected to a computer. At step S1102 a first set of metadata corresponding to a first preset channel is read from the media player 20. At step S1104 the first preset channel on the media player 20 is changed to a second preset channel. At step S1106 the media player 20 is updated with a second set of metadata corresponding to the second preset channel.

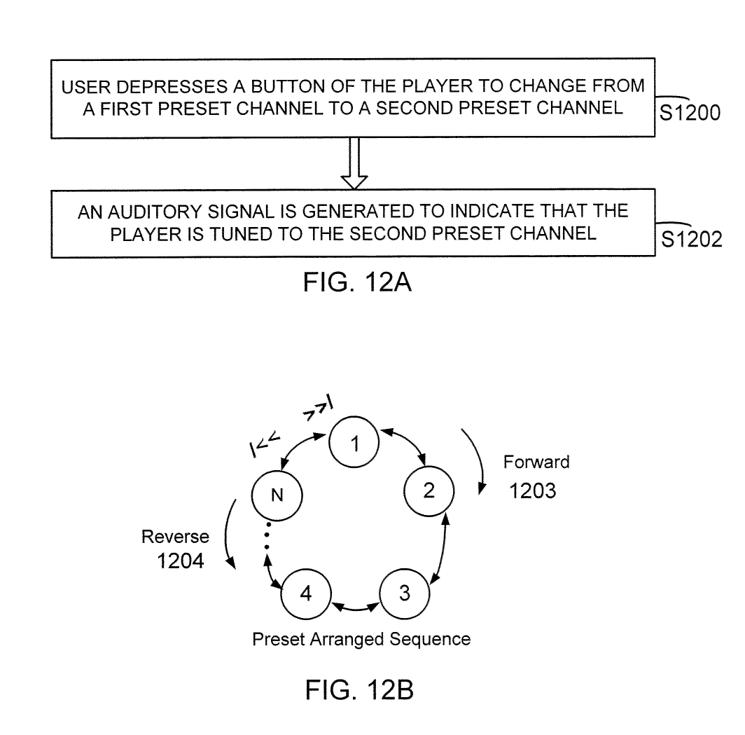

FIG. 12A illustrates a method of changing a first preset channel to a second preset channel in player 20. At step S1200, a user depresses a button of the player 20 to change from a first preset channel to a second preset channel. At step S1202, the player 20 generates an auditory signal to indicate that the player 20 is tuned to the second preset channel. The auditory signal may be generated based on a text to voice function or an audio file that is stored in memory 44 and is associated with preset channels. If the audio signal is generated using a text to audio function, then controller 50 reads text associated with a radio station frequency and converts the text to an audio signal. When an audio file is used to generate the audio signal, then processor 58 reads the audio file from non-volatile memory and audio CODEC 48 decodes the audio file to generate an audio output (49).

FIG. 12B shows an example, of a sequence for changing preset channels in player 20. The preset channels may be changed in a forward direction 1203 or a reverse direction 1204. The preset channels are shown as 1, 2, 3 . . . N. By pressing a button, the preset channels may be change from 1 to N or from N to 1.

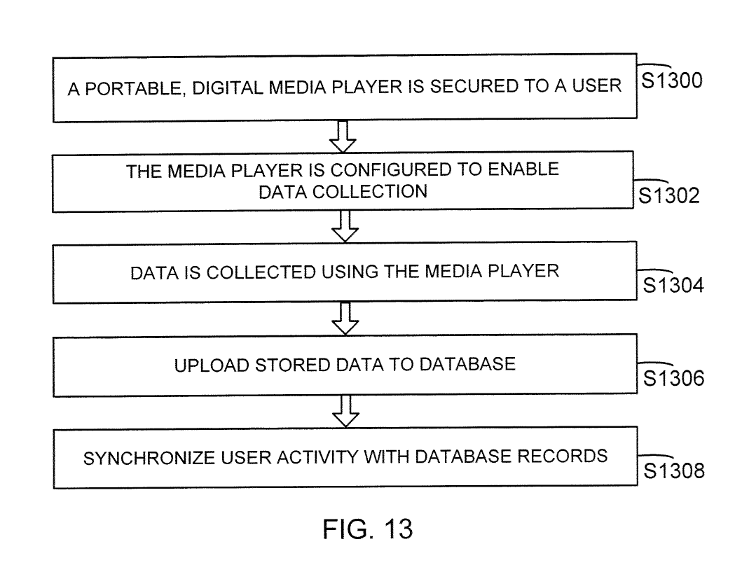

FIG. 13 illustrates a method of tracking a user parameter during exercise using the player 20. At step S1300 the player 20 is secured to the user. At step S1302 the media player 20 is configured to enable data collection for a user parameter (for example, heart beat). Player 20 may be configured by pressing one or more buttons in a pre-defined sequence. Software code to recognize the sequence, which enables memory detection, may be stored in memory 62. In another embodiment, a special data collection button may be provided that is designed to collect a user parameter. At step S1304 data related to the selected user parameter is collected using the media player 20. The data may be stored in memory 44.

In step S1306, stored data is uploaded to a computing system. Either the data is appended to an existing database (not shown) or a new database is created. The database may be located on a local computing system to which player 20 is directly attached, or stored at a remote networked computer. In one embodiment, data is uploaded to a remote computer via the Internet. In step S1308, current records are synchronized with previously stored records (in a pre-existing database). It is noteworthy that access to stored data may be restricted to authorized users, for example, a user's personal trainer, physician or others.

It is noteworthy that collected data may be uploaded from player 20 in real time (i.e. while the user is exercising), for example, via a wireless interface to a host system. In one embodiment, a single portable media player is provided that allows one listen to music while exercising and store exercise related parameters. The collected data may be used to design custom exercise programs as well as to monitor user progress during an exercise program.

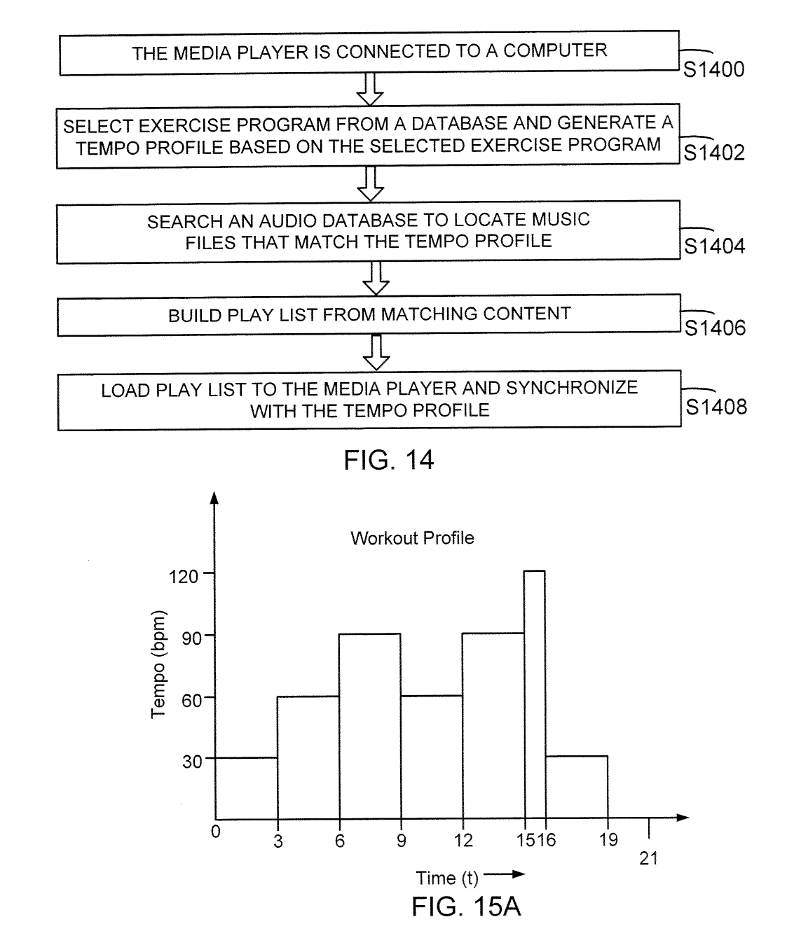

FIG. 14 illustrates a method of configuring the player 20 to provide music at desired tempos to match an exercise program. At step S1400, the media player 20 is connected to a computer. At step S1402, the user selects an exercise program. The exercise program is converted to a series of tempos with defined periods and a tempo profile is generated from the exercise program. At step S1404, an audio database is searched to locate music files that match the tempo profile. At step S1406, a play list is built from the music files. At step S1408, the play list is loaded to the media player 20. The play list is synchronized so that different tempo profiles are associated with different audio files. When the user is ready to use an exercise machine, and selects an exercise program, then based on the tempo, the associated audio files are played.

The song period and exercise duration at a tempo may not always match exactly. For example, a song duration may be three minutes while duration for a particular tempo may be 5 minutes. In this instance, the song may be looped (i.e played again) to match the tempo duration. In another instance, a tempo may be for 1 minute, while the song may be for 2 minutes. In this case, the audio file is truncated and only played for a minute. A best fit or first fit process may be used to match the tempo with audio file duration.

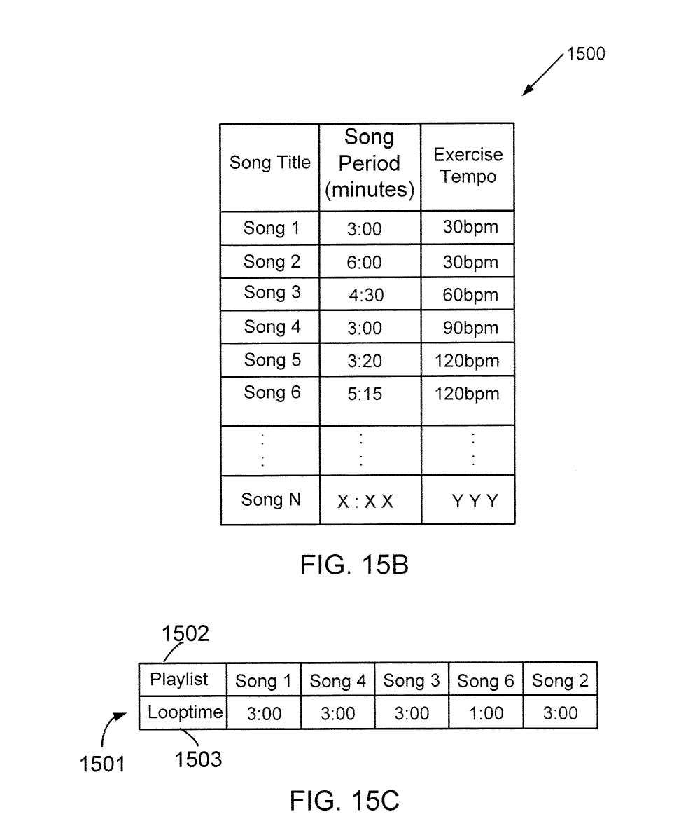

FIGS. 15A-15C show an example of associating audio files with exercise profile using player 20. FIG. 15A shows an example of an exercise profile with the tempo (in beats per minute (bpm)) on the vertical axis and time t (in minutes) on the horizontal axis. FIG. 15B shows an example of a database 1500 that matches exercise tempo with audio files (for example, songs). Column “Song Title” lists the different audio files, shown as Song 1, Song 2, . . . Song N. The column labeled “Song Period” shows the duration for different songs, while the column labeled “Exercise Tempo” shows the tempo associated with a particular song.

FIG. 15C shows a Table 1501 with playlist 1502 and associated loop time 1503. In this sequence, Song1 is first played for 3 minutes, then Song4 is played for 3 minutes, followed by Song3 for 3 minutes and so forth. The loop time and the sequence may be obtained by using the best fit or first fit process where tempo and song duration are compared to derive Table 1501.

The above description presents the best mode contemplated for carrying out the present portable, digital media player having no graphical user interface, and its associated methods, and of the manner and process of making and using it, in such full, clear, concise, and exact terms as to enable any person skilled in the art to which it pertains to make and use this player and its associated methods. This player and its associated methods are, however, susceptible to modifications and alternate constructions from those discussed above that are fully equivalent. Consequently, this player and its associated methods are not limited to the particular embodiments disclosed. On the contrary, this player and its associated methods cover all modifications and alternate constructions coming within the spirit and scope of the player and its associated methods as generally expressed by the following claims, which particularly point out and distinctly claim the subject matter of the player and its associated methods.

What is claimed is:

1. A method of changing an operational mode of a portable, digital media player, the media player without a graphical user interface, the method comprising the step of:
depressing a button of the media player to change the operational mode of the media player from a first operational mode to a second operational mode;
wherein when the media player changes from the first operational mode to the second operational mode a plurality of light-emitting diodes (LED's) associated with the media player changes from a first illumination pattern to a second illumination pattern.

2. The method of claim 1, wherein the first illumination pattern comprises sequential illumination and dimming of the LED's and the second illumination pattern comprises random illumination and dimming of the LED's.

3. The method of claim 1, wherein the first illumination pattern comprises steady illumination of the LED's and the second illumination pattern comprises repeated illumination and dimming of the LED's.

4. The method of claim 1, wherein the first illumination pattern comprises a first color and the second illumination pattern comprises a second color.

5. The method of claim 1, wherein when the button is depressed the LED's change from the first illumination pattern to a third illumination pattern to indicate that the media player is in a hold mode or locked mode and cannot be changed to the second operational mode.

6. A method of indicating an operational mode of a portable, digital media player, the media player having no graphical user interface, the method comprising the steps of:
illuminating a plurality of light-emitting diodes (LED's) associated with the media player according to a first illumination pattern when the media player is in a first operational mode; and
illuminating the LED's according to a second illumination pattern when the media player is in a second operational mode.

7. The method of claim 6, wherein the first illumination pattern comprises sequential illumination and dimming of the LED's and the second illumination pattern comprises random illumination and dimming of the LED's.

8. The method of claim 6, wherein the first illumination pattern comprises steady illumination of the LED's and the second illumination pattern comprises repeated illumination and dimming of the LED's.

9. The method of claim 6, wherein the first illumination pattern comprises a first color and the second illumination pattern comprises a second color.

10. The method of claim 6, further comprising the steps of:
depressing a button of the media player, the button being configured to change the media player from the first operational mode to the second operational mode; and
illuminating the LED's according to a third illumination pattern to indicate that the media player is in a hold mode or locked mode and cannot be changed to the second operational mode.

11. A method of indicating that a portable, digital media player without a graphical user interface is in a hold mode or locked mode, the method comprising the steps of:
illuminating a plurality of light-emitting diodes (LED's) associated with the media player according to a first illumination pattern when the media player is in a first operational mode;
depressing a button of the media player, the button being configured to change an operational mode of the media player from the first operational mode to a second operational mode; and
illuminating the LED's according to a second illumination pattern to indicate that the media player is in the hold mode or locked mode and cannot be changed to the second operational mode.

12. The method of claim 11, wherein the first illumination pattern comprises sequential illumination and dimming of the LED's and the second illumination pattern comprises random illumination and dimming of the LED's.

13. The method of claim 11, wherein the first illumination pattern comprises steady illumination of the LED's and the second illumination pattern comprises repeated illumination and dimming of the LED's.

14. The method of claim 11, wherein the first illumination pattern comprises a first color and the second illumination pattern comprises a second color.

15. A method of indicating that a portable, digital media player without a graphical user interface is changing from a first operational mode to a second operational mode, the method comprising the steps of:
illuminating a plurality of light-emitting diodes (LED's) associated with the media player according to a first illumination pattern when the media player is in a first operational mode;
depressing a button of the media player, the button being configured to change an operational mode of the media player from the first operational mode to the second operational mode; and
illuminating the LED's according to a second illumination pattern when the media player is changing from the first operational mode to the second operational mode.

16. The method of claim 15, wherein the first illumination pattern comprises sequential illumination and dimming of the LED's and the second illumination pattern comprises random illumination and dimming of the LED's.

17. The method of claim 15, wherein the first illumination pattern comprises steady illumination of the LED's and the second illumination pattern comprises repeated illumination and dimming of the LED's.

18. The method of claim 15, wherein the first illumination pattern comprises a first color and the second illumination pattern comprises a second color.

19. A method of configuring a portable, digital media player with preset channels, the media player having no graphical user interface, the method comprising the steps of:
connecting the media player to a computer;
changing a first preset channel on the media player to a second preset channel; and
updating the media player with a metadata corresponding to the second preset channel.

20. The method of claim 19, wherein a first set of metadata when available is read from the media player, and the first set of metadata corresponds to the first preset channel.

21. The method of claim 19, wherein the metadata includes at least one of a preset channel number, a preset channel frequency, station identification information, and a genre.

22. The method of claim 19, wherein the metadata includes an audio file that is associated with a preset channel.

23. The method of claim 19, wherein a text to audio function is used for changing a preset channel.

24. A method of changing a portable, digital media player without a graphical user interface from a first preset channel to a second preset channel, the method comprising the steps of:
depressing a button of the media player to change from the first preset channel to the second preset channel; and
generating an auditory signal to indicate to a user that the media player is tuned to the second preset channel.

25. The method of claim 24, wherein the auditory signal includes metadata associated with the second preset channel.

26. The method of claim 25, wherein the metadata include at least one of a preset channel number, a preset channel frequency, station identification information, and a genre.

27. The method of claim 24, wherein only a single button is used to change the first preset channel to the second preset channel.

28. The method of claim 24, wherein more than one button is used to change the first preset channel to the second preset channel.

29. A method of configuring a portable, digital media player to provide music at desired tempos to match an exercise program, the media player having no graphical user interface, the method comprising the steps of:
connecting the media player to a computer;
generating, from the exercise program, a tempo profile;
searching an audio database to locate music files that fit the tempo profile;
building a play list from the music files; and
loading the play list to the media player.

30. The method of claim 29, wherein the tempo profile includes a series of tempos, each tempo having a time period.

31. The method of claim 29, wherein the exercise program is selected from a list of available programs.

32. The method of claim 29, wherein the exercise program is customized for a user.

33. The method of claim 29, wherein the audio database is located on the computer.

34. The method of claim 29, wherein the computer is connected to a network, and the audio database is located on the network.

35. The method of claim 29, wherein the music files include metadata indicating a tempo of the music files.

36. The method of claim 29, further comprising the step of analyzing the music files to determine a tempo of each.

37. A method of tracking a user parameter during exercise, the method comprising the steps of:
securing a portable, digital media player to the user, the media player being configured to collect data regarding the user parameter while the user exercises;
configuring the media player to enable data collection; and
collecting the data using the media player.

38. The method of claim 37, further comprising the step of connecting the digital media player to a computer.

39. The method of claim 38, further comprising the step of uploading the data to the computer.

40. The method of claim 39, further comprising the step of storing the data in a database.

41. The method of claim 40, wherein the database is associated with a network.

42. The method of claim 41, further comprising the step of detecting whether the user is registered with the database.

43. The method of claim 37, wherein the user parameter is heart rate, distance traveled or average speed.

44. The method of claim 37, wherein the digital media player is without a graphical user interface.

45. A portable, digital media player having no graphical user interface, comprising:
a button configured to change an operational mode of the media player when depressed;
an illuminable indicator including a plurality of light-emitting diodes (LED's);
wherein the LED's are configured to illuminate according to a first illumination pattern when the player is in a first operational mode and to illuminate according to a second illumination pattern when the media player is in a second operational mode.

46. The media player of claim 45, wherein the first illumination pattern comprises sequential illumination and dimming of proximate LED's and the second illumination pattern comprises random illumination and dimming of the LED's.

47. The media player of claim 45, wherein the first illumination pattern comprises steady illumination of the LED's and the second illumination pattern comprises repeated illumination and dimming of the LED's.

48. The media player of claim 45, wherein the first illumination pattern comprises a first color and the second illumination pattern comprises a second color.

49. The media player of claim 45, wherein the LED's are configured to illuminate according to a third illumination pattern when the player is in a hold mode or locked mode and the button is depressed.

50. A portable, digital media player having no graphical user interface, comprising:
a button configured to change an operational mode of the media player when depressed;
an illuminable indicator including a plurality of light-emitting diodes (LED's);
wherein the LED's are configured to illuminate according to a first illumination pattern when the media player is in a hold mode or locked mode and the button is depressed.

51. The media player of claim 50, wherein the first illumination pattern comprises random illumination and dimming of the LED's, or repeated illumination and dimming of the LED's, or a first color.

52. A portable, digital media player having no graphical user interface, comprising:
a button configured to change the media player from a first preset channel to a second preset channel; and
an auditory signal generator configured to indicate to a user that the media player is tuned to the second preset channel.

53. The media player of claim 52, wherein the auditory signal includes metadata associated with the second preset channel.

54. The media player of claim 53, wherein the metadata include at least one of a preset channel number, a preset channel frequency, station identification information, and a genre.

55. The media player of claim 52, wherein the auditory signal is generated by an audio file that is associated with the second preset channel.

56. The media player of claim 52, wherein the auditory signal is generated by a text to audio function associated with the second preset channel.

57. The media player of claim 52, wherein more than one button is used to change the media player from the first preset channel to the second preset channel.

58. A portable, digital media player, comprising:
an apparatus configured to track a user parameter during exercise and collect data regarding the user parameter.

59. The media player of claim 58, wherein the apparatus comprises a pedometer or a heart rate monitor.

60. The media player of claim 58, wherein the media player is connected to a computer and the collected data is uploaded and stored in a database.

61. The media player of claim 58, wherein the user parameter is heart rate, distance traveled or average speed.

62. The media player of claim 58, wherein the media player is without a graphical user interface.
